(19) United States
(12) Patent Application Publication
(10) Pub. No.: US 2019/0377180 A1
(43) Pub. Date: Dec. 12, 2019

(54) HEAD-UP DISPLAY APPRATUS FOR VEHICLE

(71) Applicant: Hyundai Mobis Co., Ltd., Seoul (KR)

(72) Inventor: Byung Ki KIM, Yongin-si (KR)

(21) Appl. No.: 16/434,718

(22) Filed: Jun. 7, 2019

(30) Foreign Application Priority Data
Jun. 8, 2018 (KR) 10-2018-0066374

(51) Int. Cl. G02B 27/01; B60K 35/00

(52) U.S. Cl. CPC G02B 27/0149; B60R 2300/205; B60K 35/00

(57) ABSTRACT

A head-up display (HUD) apparatus for a vehicle may include: a case; a hinge mounted on the case and rotated; a holder rotatably mounted on the hinge, having a combiner installed thereon, and rotating the combiner to an open state when an external force is removed; a latch mounted on the hinge, and interlocked and rotated with the hinge; a push locking part mounted on the case, and locking or unlocking the latch according to the number of times that the latch is pressed and inserted; and a tilting part mounted on the hinge so as to move vertically, and adjusting an open angle of the combiner by restricting movement of the latch.

### CROSS-REFERENCES TO RELATED APPLICATIONS

The present application claims priority to Korean application number 10-2018-0066374, filed on Jun. 8, 2018, which is incorporated by reference in its entirety.

### BACKGROUND OF THE INVENTION

The present invention relates to a head-up display (HUD) apparatus for a vehicle, and more particularly, to an HUD apparatus for a vehicle, which enables a driver to manually open/close a combiner and minutely adjust the angle of the combiner.

In general, HUD represents a system which displays various pieces of vehicle information as a virtual image on the wind shield glass of a vehicle, such that a driver can check the vehicle information while keeping eyes forward during driving.

A combiner HUD has a structure to extend a combiner which is housed in a is vehicle at normal times, in case of necessity. The combiner HUD is divided into a horizontal combiner HUD and a vertical combiner HUD, depending on how a lighting unit is disposed according to a mounting space of the HUD in a vehicle.

The vertical combiner HUD moves and extends the combiner in a vertical direction through rotation of a cam wheel. In this case, an electric actuator drives the combiner. Thus, the vertical combiner HUD inevitably has a complex structure, and generates noise when a motor is driven.

The related art of the present invention is disclosed in Korean Patent Registration No. 10-1558658 published on Oct. 1, 2015 and entitled “Head-up display device for vehicle”.

### SUMMARY OF THE INVENTION

Embodiments of the present invention are directed to an HUD apparatus for a vehicle, which enables a driver to manually open/close a combiner and minutely adjust the angle of the combiner.

In one embodiment, an HUD apparatus for a vehicle may include: a case; a hinge mounted on the case and rotated; a holder rotatably mounted on the hinge, having a combiner installed thereon, and rotating the combiner to an open state when an external force is removed; a latch mounted on the hinge, and interlocked and rotated with the hinge; a push locking part mounted on the case, and locking or unlocking the latch according to the number of times that the latch is pressed and inserted; and a tilting part mounted on the hinge so as to move vertically, and adjusting an open angle of the combiner by restricting movement of the latch.

The case may include: a case plate; a case housing part protruding upward from an edge of the case plate so as to house the combiner therein; and a case buffer formed on the is case plate, and absorbing shock when contacting the combiner.

The case may further include: a case mounting part formed on the case plate; and a case damper installed on the case mounting part, and coupled to the holder so as to adjust rotation speed of the holder.

The hinge may include: a hinge cover coupled to the case; a hinge extension extended from the hinge cover, and supporting the tilting part; and a hinge shaft rotatably installed through the hinge cover, and coupled to the holder.

The hinge shaft may have a larger length than the hinge cover, such that both ends thereof are exposed to the outside of the hinge cover.

The holder may include: a holder body; a holder mounting part formed on the holder body, and having the combiner mounted thereon; a holder cover formed on the holder body, and covering the hinge shaft; a holder coupling part formed on the holder cover, and coupled to an end of the hinge shaft; and a holder elastic part wound around the hinge shaft, and providing a rotational force to the holder cover while one end thereof is supported by the case and the other end thereof is supported by the holder cover.

The one end of the holder elastic part may be supported by a case locking part formed in the case plate, and the other end of the holder elastic part may be supported by a holder locking part formed in the holder cover.

The latch may include: a latch rotating part interlocked with the hinge; a latch locking part mounted on the latch rotating part, and inserted into the push locking part so as to be locked or unlocked; and a latch protrusion formed on the latch rotating part, and protruded to interfere with the tilting part.

The tilting part may include: a tilting operation part screwed to the hinge so as to is adjust height, and disposed on a rotating path of the latch protrusion; and a tilting manipulation part disposed over the hinge, coupled to the tilting operation part, and rotating the tilting operation part while rotated by an external force.

The tilting manipulation part may have bumps formed on a circumferential surface thereof.

In the HUD apparatus for a vehicle in accordance with the embodiment of the present invention, locking may be removed when the driver presses the housed combiner, and the combiner may opened by its restoration force. Thus, an actuator for driving the combiner may be removed.

Furthermore, a case damper mounted on the case may be mounted on the holder so as to adjust rotation speed of the holder.

Furthermore, the holder body may be rotated by the restoring force of the holder elastic part.

Furthermore, the latch may be locked to the tilting part and restricted from rotating, and the angle of the combiner interlocked with the latch may be adjusted through height adjustment of the latch.

### BRIEF DESCRIPTION OF THE DRAWINGS

FIG. 1 schematically illustrates a head-up display (HUD) apparatus for a vehicle in accordance with an embodiment of the present invention.

FIG. 2 schematically illustrates that a combiner of the HUD apparatus for a vehicle in accordance with the embodiment of the present invention is closed.

FIG. 3 is a bottom perspective view of FIG. 2.

FIG. 4 schematically illustrates that the combiner of the HUD apparatus for a vehicle in accordance with the embodiment of the present invention is opened.

FIG. 5 schematically illustrates a case of the HUD apparatus in accordance with the embodiment of the present invention.

FIG. 6 schematically illustrates a hinge of the HUD apparatus in accordance with the embodiment of the present invention.

FIG. 7 is a bottom perspective view of FIG. 6.

FIG. 8 schematically illustrates a holder of the HUD apparatus in accordance with the embodiment of the present invention.

FIG. 9 is a bottom perspective view of FIG. 8.

FIG. 10 schematically illustrates a holder elastic part in the HUD apparatus in accordance with the embodiment of the present invention.

FIG. 11 schematically illustrates a latch when the combiner of the HUD apparatus in accordance with the embodiment of the present invention is closed.

FIG. 12 schematically illustrates the latch when the combiner of the HUD apparatus in accordance with the embodiment of the present invention is opened.

FIG. 13 schematically illustrates a tilting part of the HUD apparatus in accordance with the embodiment of the present invention.

### DESCRIPTION OF SPECIFIC EMBODIMENTS

Hereafter, a head-up display (HUD) apparatus for a vehicle in accordance with an embodiment of the present invention will be described in detail with reference to the accompanying drawings. It should be noted that the drawings are not to precise scale and may is be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

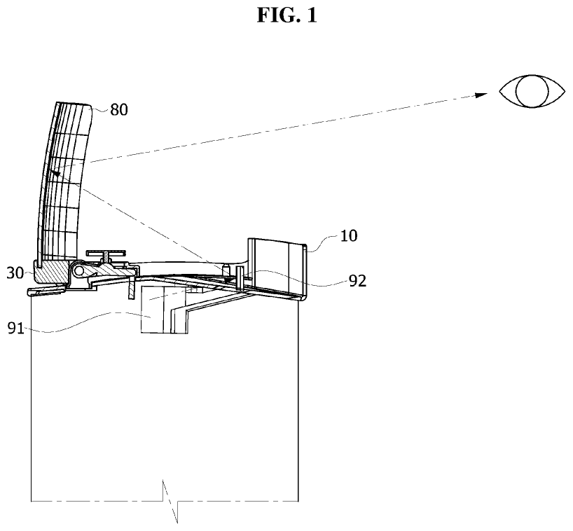

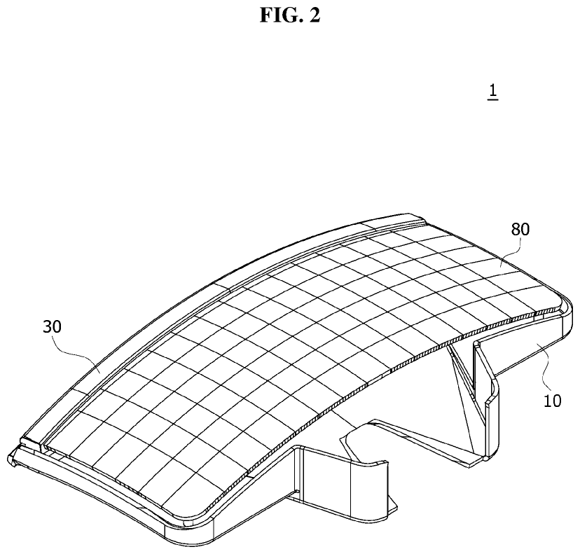

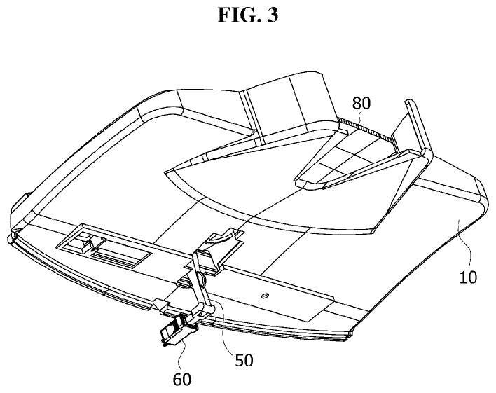

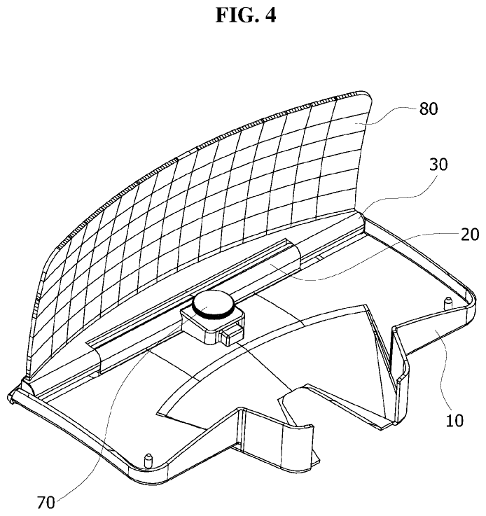

FIG. 1 schematically illustrates an HUD apparatus for a vehicle in accordance with an embodiment of the present invention, FIG. 2 schematically illustrates that a combiner of the HUD apparatus for a vehicle in accordance with the embodiment of the present invention is closed, FIG. 3 is a bottom perspective view of FIG. 2, and FIG. 4 schematically illustrates that the combiner of the HUD apparatus for a vehicle in accordance with the embodiment of the present invention is opened. Referring to FIGS. 1 to 4, the HUD apparatus 1 for a vehicle in accordance with the embodiment of the present invention may include a case 10, a hinge 20, a holder 30, a latch 50, a push locking part 60 and a tilting part 70.

The case 10 may be mounted in a vehicle, and have an image generator 91 mounted therein. The image generator 91 may generate an image or video, and irradiate a video signal onto an optical part 92 disposed in the case 10. The optical part 92 may induce the video signal provided from the image generator 91 to a combiner 80 by adjusting an optical path.

The hinge 20 may be mounted on the case 10 and rotated. For example, the hinge 20 may be disposed at the top of the case 10, and the combiner 80 may be housed at the top of the case 10.

The holder 30 may be rotatably mounted on the hinge 20, and the combiner 80 may be installed on the holder 30. Thus, as the holder 30 is rotated, the combiner 80 may be rotated into a close or open state. At this time, when the combiner 80 is opened, the combiner 80 may reflect a video signal such that a driver can recognize the video signal.

When an external force is removed, the holder 30 may be rotated in a direction to open the combiner 80. For example, a tension spring may be applied to the holder 30, such that the holder 30 can be rotated in the direction to open the combiner 80.

The latch 50 may be mounted on the hinge 20, and interlocked and rotated with the hinge 20. The push locking part 60 may be mounted in the case 10, and lock or unlock the latch 50 according to the number of times that the latch 50 is pressed and inserted.

For example, the latch 50 may be locked when the latch 50 is pressed and inserted into the push locking part 60 once, and unlocked when the locked latch 50 is additionally pressed and inserted into the push locking part 60. At this time, the push locking part 60 may have a heart-shaped locking unit installed therein, and various parts which are repeatedly locked or unlocked according to the number of times that the parts are pressed or inserted may be employed.

The tilting part 70 may be mounted on the hinge 20 so as to be movable in the vertical direction, and adjust an open angle of the combiner 80 by restricting the movement of the latch 50. For example, a driver may adjust the angle of the combiner 80 to recognize a video signal of the combiner 80 at the level of the driver's eyes.

Therefore, when the combiner 80 is pressed and inserted into the case 10, the latch 50 may be inserted into the push locking part 60, and then locked. Then, when the driver additionally presses the combiner 80, the locking between the latch 50 and the push locking part 60 may be removed. When the locking between the latch 50 and the push locking part 60 is removed, the combiner 80 may be rotated and opened by a restoring force of the holder 30.

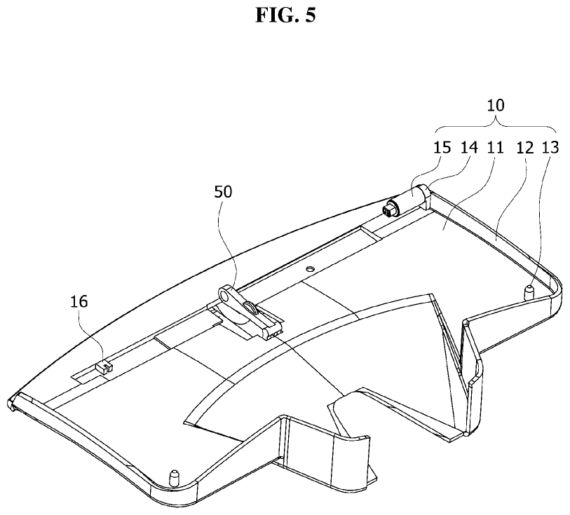

FIG. 5 schematically illustrates the case of the HUD apparatus in accordance with is the embodiment of the present invention. Referring to FIG. 5, the case 10 in accordance with the embodiment of the present invention may include a case plate 11, a case housing part 12 and a case buffer 13.

The case plate 11 may be disposed at the top of the case 10, and the image generator 91 may be disposed under the case plate 11.

The case housing part 12 may protrude upward from the edge of the case plate 11 so as to house the combiner 80. That is, the case housing part 12 may cover the combiner 80 from a position beyond the rotation path of the combiner 80.

The case buffer 13 may be formed on the case plate 11, and serve to absorb shock when contacting the combiner 80. For example, the case buffer 13 may be made of an elastic material, and one or more case buffers 13 may be formed on the case plate 11.

The case 10 in accordance with the embodiment of the present invention may include further include a case mounting part 14 and a case damper 15.

The case mounting part 14 may be formed on the case plate 11. For example, the case mounting part 14 may protrude upward from the case plate 11.

The case damper 15 may be installed on the case mounting part 14, and coupled to the holder 30 so as to adjust the rotation speed of the holder 30. For example, one end of the case damper 15 may be fixed to the case mounting part 14, and the other end of the case damper 15 may be connected to the holder 30 to induce smooth rotation of the holder 30.

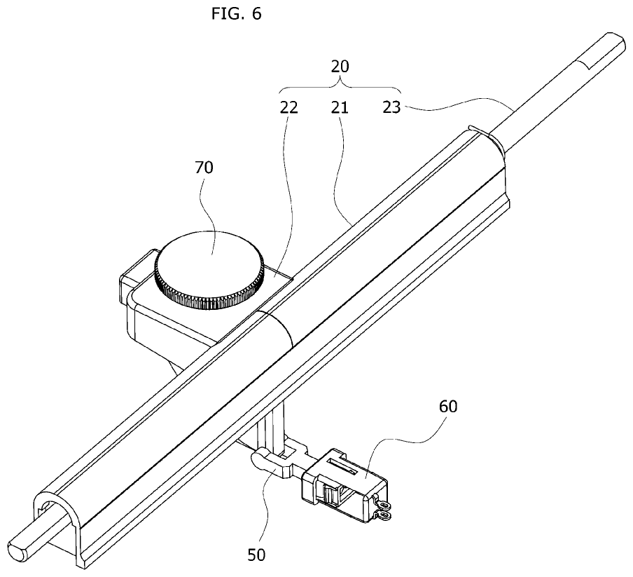

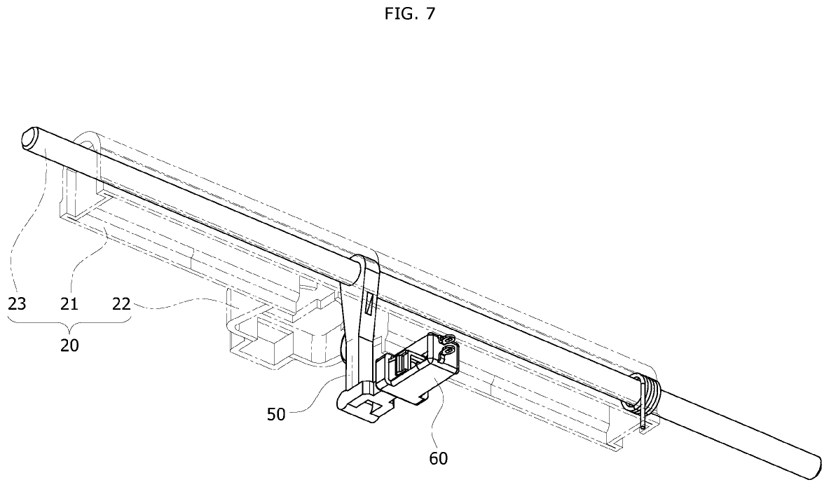

FIG. 6 schematically illustrates the hinge of the HUD apparatus in accordance with the embodiment of the present invention, and FIG. 7 is a bottom perspective view of FIG. 6. Referring to FIGS. 6 and 7, the hinge 20 in accordance with the embodiment of the present invention may include a hinge cover 21, a hinge extension 22 and a hinge shaft 23.

The hinge cover 21 may be coupled to the case 10. For example, the hinge cover 21 may have an open bottom, and have a length in the width direction of the case plate 11.

The hinge extension 22 may be extended from the hinge cover 21 and support the tilting part 70. For example, the hinge extension 22 may protrude laterally from the central portion of the hinge cover 21.

The hinge shaft 23 may be rotatably installed through the hinge cover 21, and coupled to the holder 30. For example, since the hinge shaft 23 is longer than the hinge cover 21, the hinge shaft 23 may pass through an end of the hinge cover 21. Both ends of the hinge shaft 23 may be exposed, and formed in an angled shape.

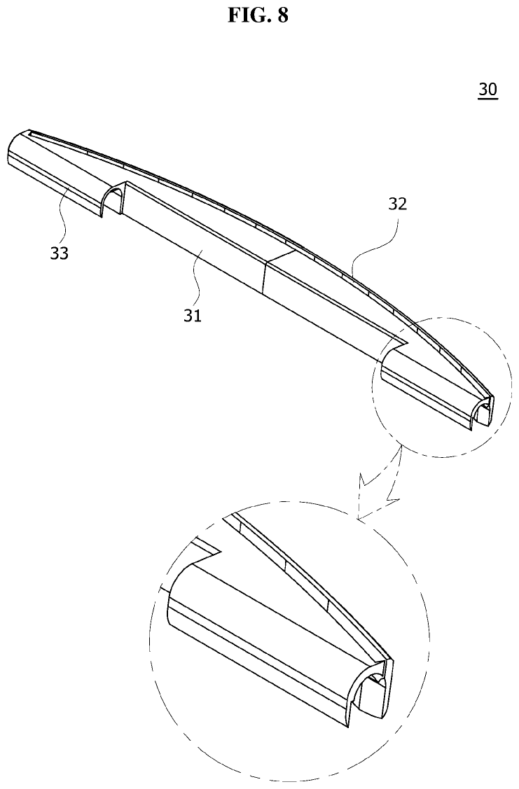

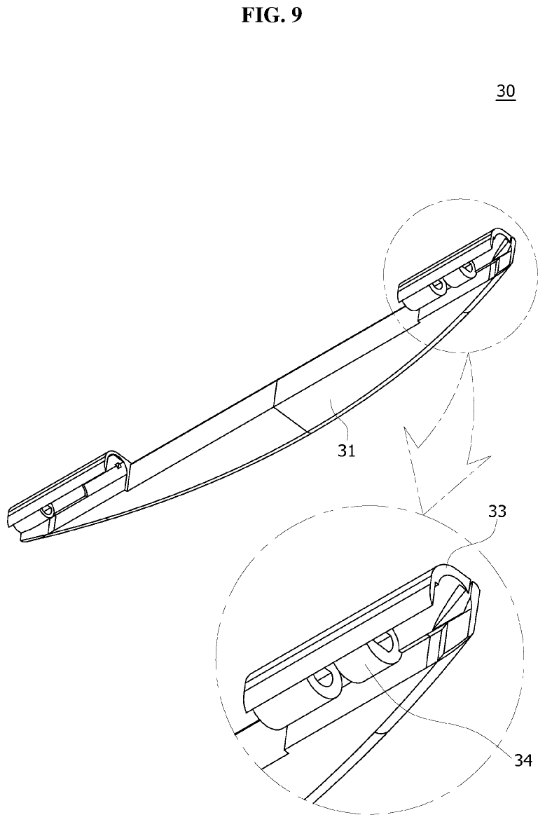

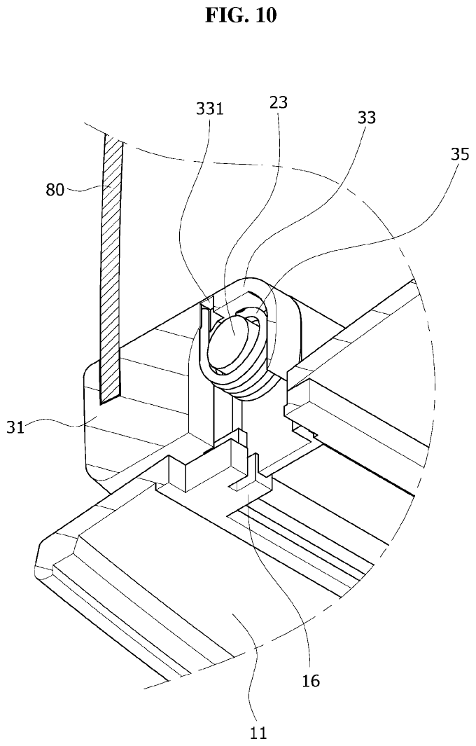

FIG. 8 schematically illustrates the holder of the HUD apparatus in accordance with the embodiment of the present invention, FIG. 9 is a bottom perspective view of FIG. 8, and FIG. 10 schematically illustrates a holder elastic part in the HUD apparatus in accordance with the embodiment of the present invention. Referring to FIGS. 8 to 10, the holder 30 in accordance with the embodiment of the present invention may include a holder body 31, a holder mounting part 32, a holder cover 33, a holder coupling part 34 and a holder elastic part 35.

The holder body 31 may have a length in the longitudinal direction of the hinge 20. For example, the holder body 31 may have a length in the width direction of the case plate 11, and the length of the holder body 31 may be larger than that of the hinge shaft 23.

The holder mounting part 32 may be formed on the holder body 31, and the combiner 80 may be mounted on the holder mounting part 32. For example, the holder mounting part 32 may be formed in the longitudinal direction of the holder body 31, and have a groove into which the combiner 80 can be inserted.

The holder cover 33 may be formed on the holder body 31 so as to cover the is hinge shaft 23. For example, the holder cover 33 may be formed as one body with the holder body 31, and cover a part of the hinge shaft 23.

The holder coupling part 34 may be formed on the holder cover 33, and coupled to an end of the hinge shaft 23. For example, the holder coupling part 34 may be formed inside the holder cover 33, and the end of the hinge shaft 23 may be coupled to the holder coupling part 34. At this time, since the end of the hinge shaft 23 is formed in an angled shape, the hinge shaft 23 and the holder coupling part 34 may be interlocked with each other.

The holder elastic part 35 may be wound around the hinge shaft 23, and provide a rotational force to the holder cover 33 while one end thereof is supported by the case 10 and the other end thereof is supported by the holder cover 33. That is, the holder elastic part 35 may serve to provide a substantial rotational force to the holder 30 coupled to the hinge shaft 23. For example, one end of the holder elastic part 35 may be supported by a case locking part 16 formed in the case plate 11, and the other end of the holder elastic part 35 may be supported by a holder locking part 331 formed in the holder cover 33.

The holder 30 and the combiner 80 may be injection-molded as a single part.

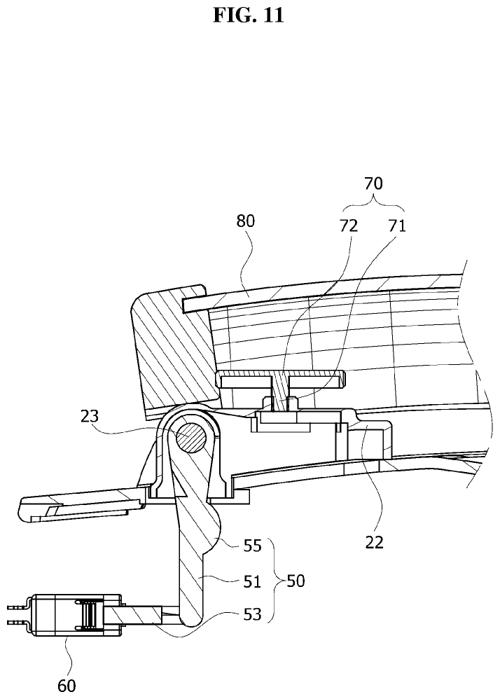

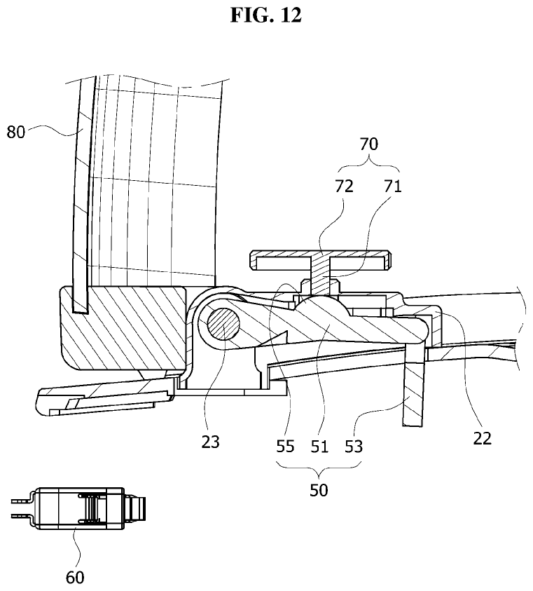

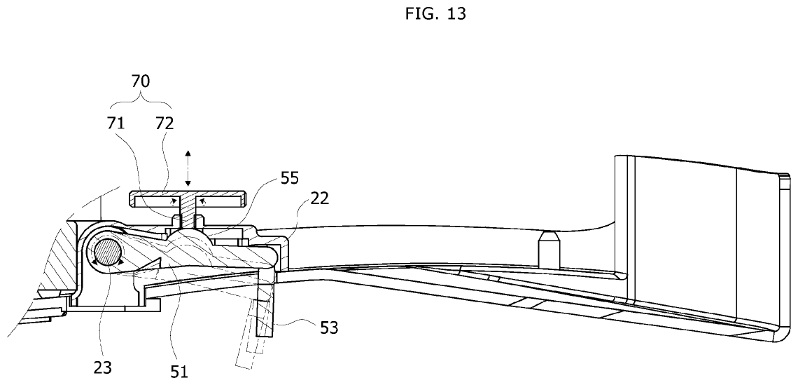

FIG. 11 schematically illustrates the latch when the combiner of the HUD apparatus in accordance with the embodiment of the present invention is closed, FIG. 12 schematically illustrates the latch when the combiner of the HUD apparatus in accordance with the embodiment of the present invention is opened, and FIG. 13 schematically illustrates the tilting part of the HUD apparatus in accordance with the embodiment of the present invention. Referring to FIGS. 11 to 13, the latch 50 in accordance with the embodiment of the present invention may include a latch rotating part 51, a latch locking part 53 and a latch protrusion 55.

The latch rotating part 51 may be interlocked with the hinge 20. For example, is one end of the latch rotating part 51 may be coupled to the hinge shaft 23, and rotated with the hinge shaft 23.

The latch locking part 53 may be mounted on the latch rotating part 51, and inserted into the push locking part 60 so as to be locked or unlocked. For example, the latch locking part 53 may be mounted at the other end of the latch rotating part 51 so as to be rotate within a predetermined angle. At this time, an over-stroke may be required to couple the latch locking part 53 and the push locking part 60 to each other, and the latch locking part 53 may be designed to have a length that does not deviate from coupling tolerance.

The latch protrusion 55 may be formed on the latch rotating part 51, and protruded to interfere with the tilting part 70. For example, the latch protrusion 55 having a circumferential surface may be protruded from the top of the latch rotating part 51, or specifically a surface facing the inside of the hinge 20, and contacted with the tilting part 70.

The tilting part 70 in accordance with the embodiment of the present invention may include a tilting operation part 71 and a tilting manipulation part 72.

The tilting operation part 71 may be screwed to the hinge 20 so as to adjust height, and disposed on a rotation path of the latch protrusion 55. For example, the bottom of the tilting operation part 71 installed through the hinge extension 22 may press the latch protrusion 55 to adjust the angle of the combiner 80.

The tilting manipulation part 72 may be disposed over the hinge 20, coupled to the tilting operation part 71, and rotated by an external force so as to rotate the tilting operation part 71. For example, the tilting manipulation part 72 may be formed in a disk shape, disposed over the hinge extension 22, and have bumps formed on the circumferential surface thereof so as to prevent a slip when a driver holds the tilting manipulation part 72 with his fingers.

The latch 50, the push locking part 60 and the tilting part 70 may be disposed in the center of the combiner 80. However, since the tilting part 70 may be reflected through the combiner 80 and exposed to the driver's view, the latch 50 and the tilting part 70 including the push locking part 60 may be disposed at an edge of the combiner 80.

The operation of the HUD apparatus for a vehicle in accordance with the embodiment of the present invention will be described as follows.

When the combiner 80 is closed (refer to FIG. 2), the combiner 80 may be partially inserted into the case 10. At this time, as the latch 50 is locked by the push locking part 60, the hinge shaft 23 interlocked with the latch 50 and the holder 30 coupled to the hinge shaft 23 may be restricted from rotating.

In such a state, when a driver presses the combiner 80, the holder 30 may be rotated to move the latch 50 toward the push locking part 60, and the locking between the push locking part 60 and the latch 50 may be removed as the latch 50 is additionally inserted into the push locking part 60.

When the locking of the latch 50 is removed, the holder body 31 may be rotated by the restoration force of the holder elastic part 35, and the combiner 80 may be opened (refer to FIG. 4).

The driver may rotate the tilting manipulation part 72 in one direction to move the tilting operation part 71 downward, or rotate the tilting manipulation part 72 in the other direction to move the tilting operation part 71 upward. Such a manipulation can minutely adjust the angle of the opened combiner 80.

A switch is mounted inside the push locking part 60. The switch can sense whether the combiner 80 is closed.

In the HUD apparatus 1 for a vehicle in accordance with the embodiment of the present invention, the locking may be removed when the driver presses the housed combiner 80, and the combiner 80 may opened by its restoration force. Thus, an actuator for driving the combiner 80 may be removed.

Furthermore, the case damper 15 mounted on the case 10 may be mounted on the holder 30 so as to adjust the rotation speeds of the holder 30 and the combiner 80 interlocked with the holder 30.

Furthermore, the latch 50 may be locked to the tilting part 70 and restricted from rotating, and the angle of the combiner 80 interlocked with the latch 50 may be adjusted through the height adjustment of the latch 50.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A head-up display (HUD) apparatus for a vehicle, comprising:
a case;
a hinge mounted on the case and configured to be rotatable;
a holder rotatably mounted on the hinge, having a combiner disposed thereon, and configured to rotate the combiner to an open state when an external force is removed;
a latch mounted on the hinge and configured to be interlocked and rotated with the hinge;
a push locking part mounted on the case and configured to lock or unlock the latch according to a number of times that the latch is pressed and inserted; and
a tilting part mounted on the hinge and configured to move vertically and configured to adjust an open angle of the combiner by restricting movement of the latch.

2. The HUD apparatus of claim 1, wherein the case comprises:
a case plate;
a case housing part protruding upward from an edge of the case plate to house the combiner therein; and
a case buffer formed on the case plate and configured to absorb shock when contacting the combiner.

3. The HUD apparatus of claim 2, wherein the case further comprises:
a case mounting part formed on the case plate; and
a case damper installed on the case mounting part and coupled to the holder to adjust rotation speed of the holder.

4. The HUD apparatus of claim 2, wherein the hinge comprises:
a hinge cover coupled to the case;
a hinge extension extended from the hinge cover and configured to support the tilting part; and
a hinge shaft rotatably installed through the hinge cover, and coupled to the holder.

5. The HUD apparatus of claim 4, wherein the hinge shaft has a larger length than the hinge cover, such that both ends thereof are exposed to an outside of the hinge cover.

6. The HUD apparatus of claim 4, wherein the holder comprises:
a holder body;
a holder mounting part formed on the holder body and having the combiner mounted thereon;
a holder cover formed on the holder body and configured to cover the hinge shaft;
a holder coupling part formed on the holder cover and coupled to an end of the hinge shaft; and
a holder elastic part wound around the hinge shaft and configured to provide a rotational force to the holder cover while one end thereof is supported by the case and another end thereof is supported by the holder cover.

7. The HUD apparatus of claim 6, wherein the one end of the holder elastic part is supported by a case locking part formed in the case plate, and the another end of the holder elastic part is supported by a holder locking part formed in the holder cover.

8. The HUD apparatus of claim 1, wherein the latch comprises:
a latch rotating part interlocked with the hinge;
a latch locking part mounted on the latch rotating part and inserted into the push locking part configured to be locked or unlocked; and
a latch protrusion formed on the latch rotating part, and protruded to interfere with the tilting part.

9. The HUD apparatus of claim 8, wherein the tilting part comprises:
a tilting operation part screwed to the hinge to adjust a height of the tilting part and disposed on a rotating path of the latch protrusion; and
a tilting manipulation part disposed over the hinge, coupled to the tilting operation part, and configured to rotate the tilting operation part while rotated by an external force.

10. The HUD apparatus of claim 9, wherein the tilting manipulation part has bumps disposed on a circumferential surface thereof.
